(19) United States
(12) Patent Application Publication
(10) Pub. No.: US 2023/0321805 A1
(43) Pub. Date: Oct. 12, 2023

(54) HANDHELD RAILWAY SPIKE PULLER

(71) Applicant: Melvelle Equipment Corp. Pty Ltd, New South Wales (AU)

(72) Inventors: Jason Casboult, New South Wales (AU); Ben Holmes, New South Wales (AU)

(21) Appl. No.: 18/295,633

(22) Filed: Apr. 4, 2023

(30) Foreign Application Priority Data
Apr. 6, 2022 (AU) 2022900900

(51) Int. Cl. B25C 11/02; E01B 29/26

(52) U.S. Cl. CPC B25C 11/02; E01B 29/26

(57) ABSTRACT

The present invention is directed to a handheld railway spike puller. The spike puller is adapted to operate for pulling of a railway spike from a sleeper and its associated sleeper plate. The spike puller is adapted for coupling with a rotational driver in the form of battery-powered impact wrench. The spike puller generally includes a housing assembly being generally elongate and at a proximal end adapted for detachable coupling with the impact wrench, a drive screw substantially housed within the housing assembly, and arranged for rotation via the impact wrench, a slide assembly including an internal thread configured to engage an external thread of the drive screw which on rotation in a forward direction and a reverse direction effects sliding movement of the slide assembly within the housing assembly between an extended position and a retracted position, respectively. The internal and external threads are designed on rotation of the drive screw in the forward direction to release from one another in the extended position of the slide assembly. Biasing means includes a spring operatively coupled to the drive screw. The biasing means is arranged on release of the internal and external threads to urge the slide assembly in the extended position axially toward the drive screw.

### TECHNICAL FIELD

The present invention is broadly directed to a handheld railway spike puller.

### BACKGROUND

Rail spikes are used in rail fastening systems for fixing a rail to an underlying sleeper via a sleeper plate. The rail spike is designed to secure the sleeper plate to the associated sleeper with the rail being anchored to the sleeper plate via a head of the rail spike or other rail fastening system. Rail spikes are typically removed from a sleeper and associated sleeper plate using a crowbar. More recently it has been known to remove rail spikes using a portable device battery-powered for extraction of the rail spike via an impact wrench or other driver. This type of portable device is exemplified by the rail spike puller of U.S. Pat. No. 10,597,828. The spike puller of the preferred embodiment of this US patent includes a main column which houses a drive shaft at one end arranged to cooperate for rotation within a bearing assembly and at an opposite end being threaded for engagement with a mounting flange and nut arrangement. The mounting flange and nut arrangement is connected via a plurality of standoffs with an extractor plate configured to releasably engage a head of a rail spike. Rotation of the drive shaft via a torque wrench effects sliding movement of the extractor plate within the main column to extract the rail spike from an associated sleeper.

### SUMMARY OF INVENTION

According to the present invention there is provided a handheld railway spike puller comprising:
a housing assembly being generally elongate and at a proximal end adapted for coupling with a rotational driver;
a drive screw substantially housed within the housing assembly, said drive screw arranged for rotation via the rotational driver;
a slide assembly including an internal thread configured to engage an external thread of the drive screw which on rotation in a forward direction and a reverse direction effects sliding movement of the slide assembly within the housing assembly between an extended position and a retracted position, respectively, the internal and external threads designed on rotation of the drive screw in the forward direction to release from one another in the extended position of the slide assembly;
biasing means operatively to the drive screw, said biasing means being arranged on release of the internal and external threads to urge the slide assembly in the extended position axially toward the drive screw wherein rotation of the drive screw in the reverse direction effects re-engagement of the internal and external threads under the influence of the biasing means thereby providing sliding movement of the slide assembly toward the retracted position.

Preferably the spike puller also comprises a pair of jaws associated with the slide assembly and arranged in the extended position of the slide assembly to be exposed from a distal end of the housing assembly for engagement of said jaws with a rail spike. More preferably the pair of jaws are pivotally coupled to one another and mounted to a distal end of the slide assembly via a clevis pin and mounting arrangement which on movement of the slide assembly toward the retracted position provides a scissoring action in the pair of jaws clamping about the rail spike and pulling it from a sleeper or associated sleeper plate. Still more preferably the housing assembly includes a foot arrangement at its distal end being adapted to contact the sleeper or the associated plate, said foot arrangement being designed during movement of the slide assembly between the extended and retracted positions to transmit axial forces from the drive screw and the slide assembly through the housing assembly to the sleeper or the associated plate for pulling of the rail spike from said sleeper or plate.

Preferably the slide assembly includes a drive nut including the internal thread, said drive nut being mounted to a slide casing at its proximal end. More preferably the slide casing is hollow including a drive screw cavity arranged for receipt of a distal end of the drive screw during movement of the slide assembly between its extended and retracted positions. Still more preferably the slide assembly also includes one or more slide bushes mounted to the slide casing, said bushes being configured to cooperate with the housing assembly to permit axial movement of said slide assembly between the extended and retracted positions whilst preventing rotational movement relative to the housing assembly.

Preferably the external thread of the drive screw terminates at a reduced diameter portion of said drive screw adjacent its distal end, the biasing means including a spring mounted about part of the reduced diameter portion and arranged on release of the internal and external threads in the extended position of the slide assembly to urge the slide assembly axially toward the drive screw. More preferably the biasing means also includes a spring nut mounted at the distal end of the drive screw and arranged for abutment with the spring. Still more preferably the axial length of the spring of the biasing means in its relaxed state combined with the axial length of the reduced diameter portion of the drive screw are together slightly greater than the axial length of the internal thread of the drive nut thereby ensuring the spring is effective in urging the slide assembly in the extended position toward the drive screw for re-engagement of the internal and external threads with rotation of the drive screw in the reverse direction.

Preferably the internal thread of the drive nut and the external thread of the drive screw are of a trapezoidal thread form. More preferably each of the internal and external threads are tapered at their proximal and distal ends, respectively, said tapered ends being configured to promote re-engagement of said threads under the influence of the biasing means with the slide assembly in the extended position and upon rotation of the drive screw in the reverse direction.

Preferably the housing assembly also includes a bearing arrangement fixed to an outer casing of the housing assembly at its proximal end, said bearing arrangement mounted about a proximal end of the drive screw and configured to prevent axial movement of said drive screw whilst permitting rotation of said screw in both the forward and reverse directions. More preferably the housing assembly further includes a driver housing mounted to a bearing housing of the bearing arrangement, said driver housing adapted for detachable coupling with the rotational driver.

### BRIEF DESCRIPTION OF DRAWINGS

In order to achieve a better understanding of the nature of the present invention a preferred embodiment of a handheld railway spike puller will now be described, by way of example only, with reference to the accompanying drawings in which:

FIG. 1 is a sectional view of a preferred embodiment of a handheld spike puller according to the present invention;

FIGS. 2A to 2C are sectional views of the handheld railway spike puller of the preferred embodiment of FIG. 1 shown in part and depicting its operation in pulling a railway spike from a sleeper and associated sleeper plate;

FIGS. 3A to 3C are sectional and alternate isometric views of a slide assembly of the handheld railway spike puller of the preferred embodiment taken from FIG. 1;

FIGS. 4A and 4B are sectional and side elevational views of the handheld railway spike puller of the preferred embodiment of FIG. 1 shown without its outer casing;

FIG. 5 is an isometric view of the drive screw taken from the preferred embodiment of the handheld railway spike puller of FIG. 1 together with a drive nut of the associated slide assembly shown in an intermediate position between extended and retracted positions of said slide assembly;

FIG. 6 is a sectional view of a distal end of the drive screw and cooperating drive nut of the slide assembly taken from the preferred embodiment of the handheld railway spike puller of FIG. 1 shown with the slide assembly in the extended position with the internal and external threads released from one another;

FIG. 7 is an isometric and detail view of the drive nut and tapered thread detail of the slide assembly taken from the preferred embodiment of the handheld railway spike puller of FIG. 1.

### DETAILED DESCRIPTION

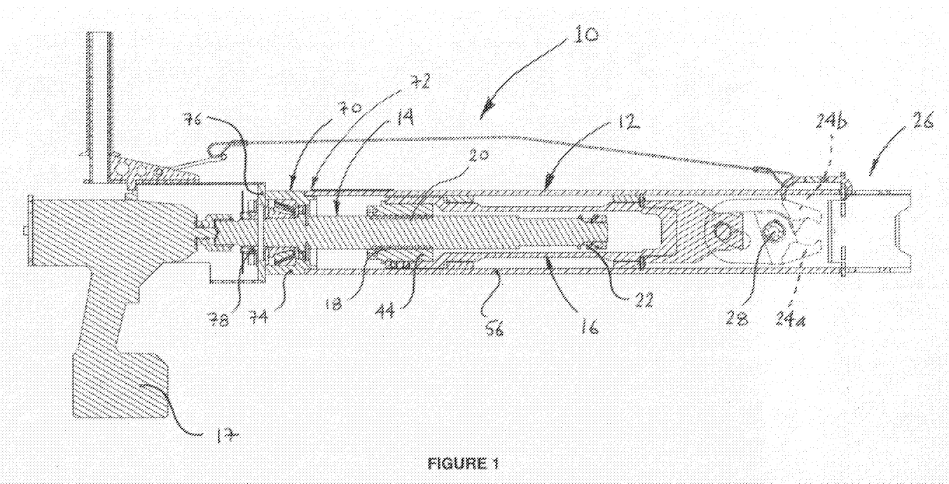

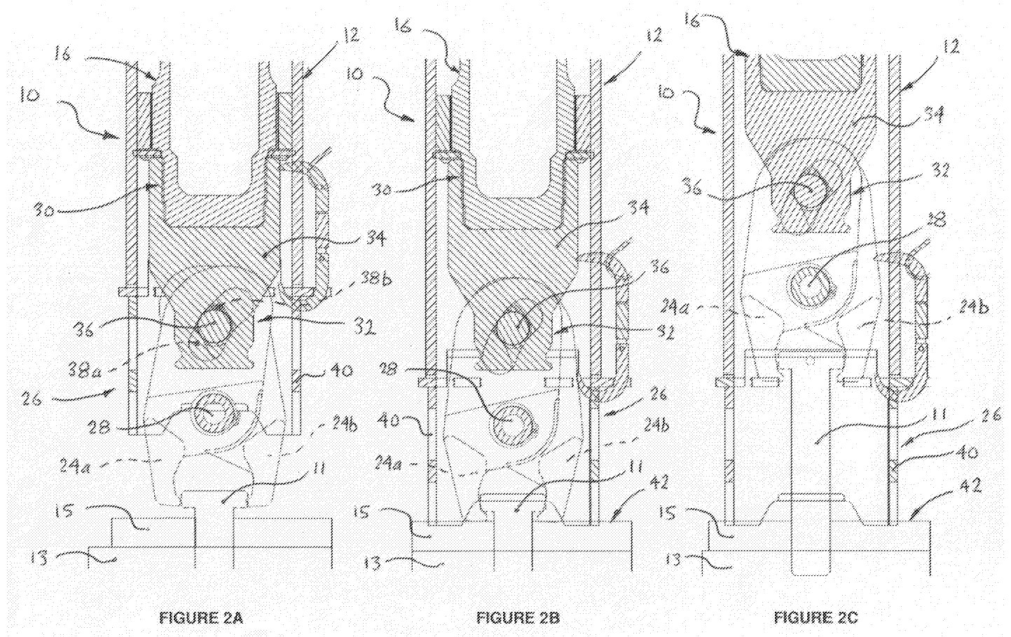

As seen in FIGS. 1 and 2 there is a handheld railway spike puller 10 of a preferred embodiment of the present invention. The handheld railway spike puller 10 is adapted to operate for pulling of a railway spike 11 from a sleeper 13 and its associated sleeper plate 15. In this embodiment the handheld spike puller 10 is adapted for coupling with a rotational driver in the form of battery-powered impact wrench 17.

The handheld railway spike puller 10 of this embodiment generally comprises:
1. a housing assembly 12 being generally elongate and at a proximal end adapted for detachable coupling with the impact wrench 17;
2. a drive screw 14 substantially housed within the housing assembly 12, said screw 14 arranged for rotation via the impact wrench 17;
3. a slide assembly 16 including an internal thread 18 configured to engage an external thread 20 of the drive screw 14 which on rotation in a forward direction and a reverse direction effects sliding movement of the slide assembly 16 within the housing assembly 12 between an extended position and a retracted position, respectively, the internal and external threads 18 and 20 designed on rotation of the drive screw 14 in the forward direction to release from one another in the extended position of the slide assembly 16;
4. biasing means including a spring 22 operatively coupled to the drive screw 14, said biasing means 22 being arranged on release of the internal and external threads 18 and 20 to urge the slide assembly 16 in the extended position axially toward the drive screw 14.

Importantly, the biasing means or its spring 22 urge the slide assembly 16 in the extended position axially toward the drive screw 14 wherein rotation of the drive screw 14 in the reverse direction effects re-engagement of the internal and external threads 18 and 20. This re-engagement of the internal and external threads 18 and 20 is promoted under the influence of the biasing means or spring 22 whereby continued rotation of the drive screw 14 in the first direction effects sliding movement of the slide assembly 16 within the housing assembly 12 toward the retracted position of the slide assembly 16. In this example, the impact wrench 17 rotates the drive screw 14 in the forward or counter-clockwise direction for sliding movement of the slide assembly 16 toward the extended position whereas rotation of the drive screw 14 in the reverse or clockwise direction effects sliding movement of the slide assembly 16 toward the retracted position.

As best seen in FIGS. 2A and 2B, the handheld spike puller 10 of this embodiment also comprises a pair of jaws 24a and 24b associated with the slide assembly and arranged in the extended position of the slide assembly 16 to be exposed from a distal end 26 of the housing assembly 12. The jaws 24a/b are arranged in this extended position for engagement with a head of the rail spike 11, see FIG. 2A. The pair of jaws 24a/b are pivotally coupled to one another via pivot pin 28 and mounted to a distal end 30 of the slide assembly 16 via a clevis pin and mounting arrangement 32. The clevis pin and mounting arrangement 32 of this example includes a clevis 34 threaded or otherwise fixed to the distal end 30 of the slide assembly 16, and a clevis pin 36 arranged for mounting of the pair of jaws 24a/b to the clevis 34. The pair of jaws 24a/b include curved slots 38a and 38b respectively configured to provide a scissoring action in the jaws 24a/b on movement of the slide assembly 16 toward the retracted position, see FIG. 2B. It will be understood that continued movement of the slide assembly 16 toward the retracted position via the action of the drive screw 14 effects clamping of the jaws 24a/b about the rail spike 11 pulling it from the sleeper 13 and associated sleeper plate 15, see FIG. 2C.

In this embodiment, the housing assembly 12 includes a foot arrangement 40 at its distal end 42 being adapted in operation to contact the associated sleeper plate 15. As seen in FIGS. 2B and 2C, the foot arrangement 40 is designed during movement of the slide assembly 16 between the extended and retracted positions to transmit axial forces to the sleeper plate 15 with which it makes contact. These axial forces are transmitted from the drive screw 14 and the slide assembly 16 through the housing assembly 12 for pulling of the rail spike 11 from the sleeper 13 and the sleeper plate 15.

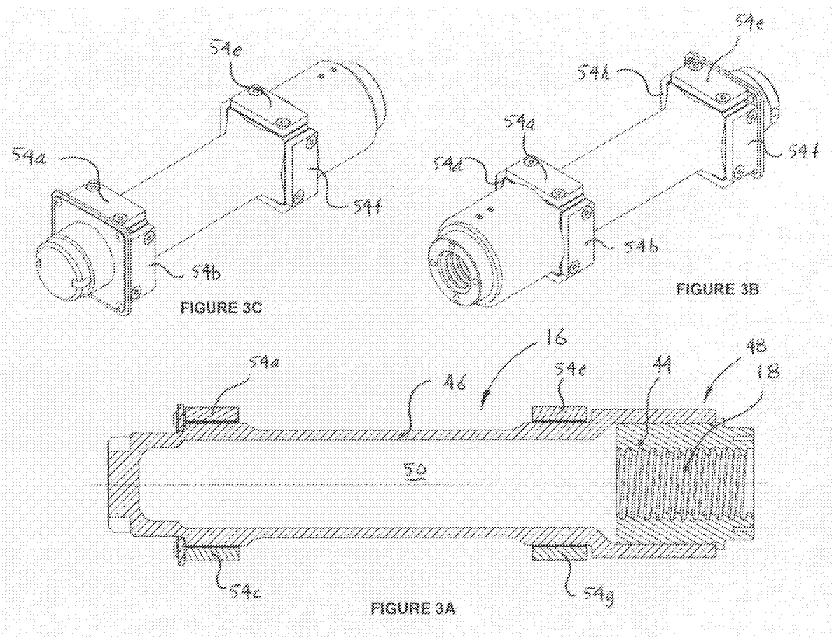

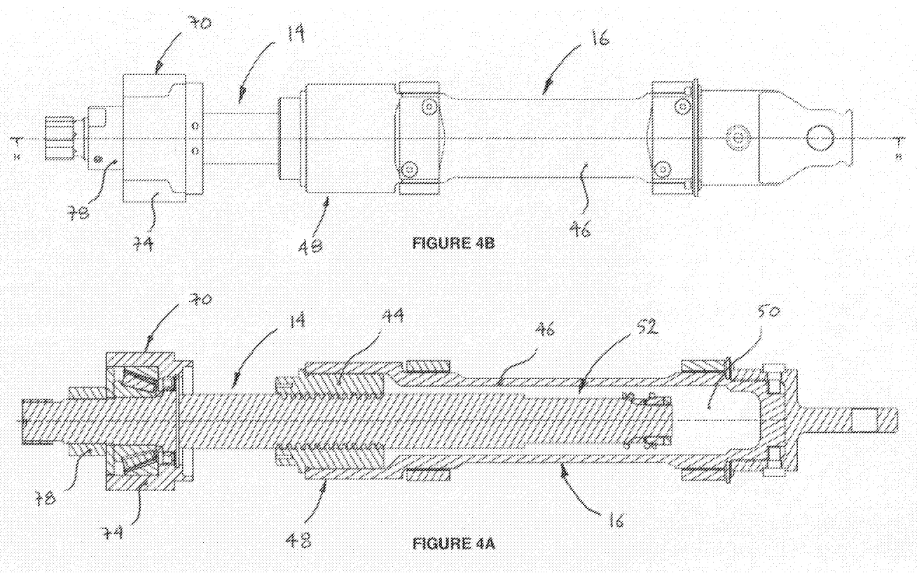

As best seen in FIGS. 3 and 4, the slide assembly 16 includes a drive nut 44 including the internal thread 18, the drive nut 14 being mounted or in this example threaded internally of a slide casing 46 at its proximal end 48. The slide casing 46 is hollow including a drive screw cavity 50 arranged for receipt of a distal end 52 of the drive screw 14 during movement of the slide assembly 16 between its extended and retracted positions. The slide assembly 16 also includes slide bushes such as 54a to 54h mounted to the slide casing 46 and configured to cooperate internally with the housing assembly 12 to permit axial movement of the slide assembly 16 between the extended and retracted positions. Returning to FIG. 1, the housing assembly 12 includes an outer casing 56 which is in the form of a SHS. The SHS casing 56 is internally shaped substantially complementary to the general profile shape of the slide bushes such as 54a to 54h mounted to the slide casing 46. It will be understood that this arrangement prevents rotational movement of the slide assembly 16 relative to the housing assembly 12 enabling axial or translational movement of the slide assembly 16 on rotation of the cooperating drive screw 14.

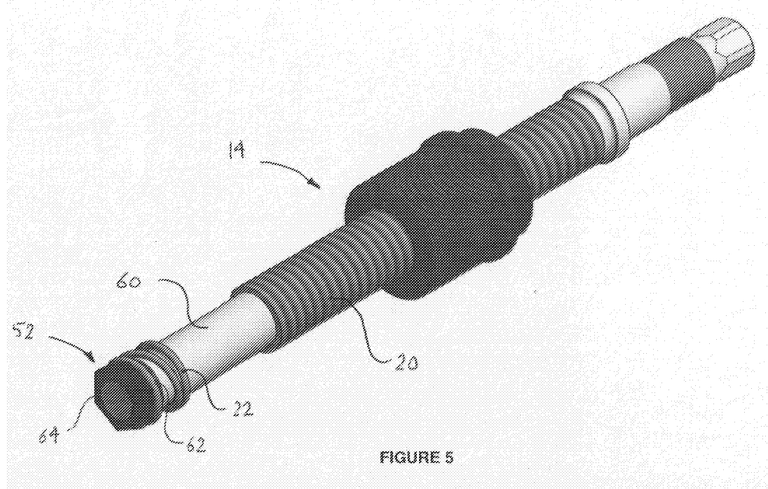

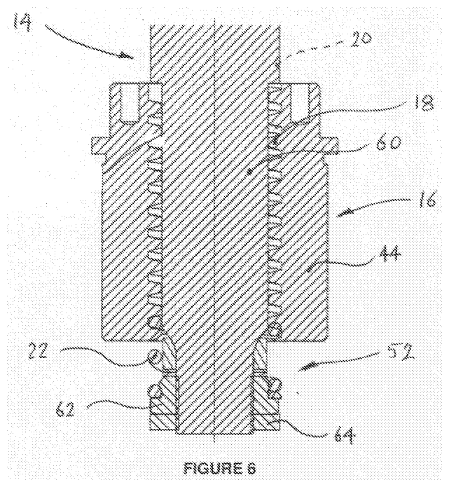

As best seen in FIGS. 5 and 6, the external thread 20 of the drive screw 14 terminates at a reduced diameter portion 60 of the drive screw 14 adjacent its distal end 52. In this example, the biasing means or the spring 22 is mounted about part of the reduced diameter portion 60. This arrangement ensures that the spring 22 on release of the internal and external threads 18 and 20 in the extended position of the slide assembly 16 urges the slide assembly 16 axially toward the drive screw 14. In this embodiment, the biasing means also includes a spring nut 62 and associated lock nut 64 screw fitted or otherwise mounted to the distal end 52 of the drive screw 14 for abutment of the spring 22 with the spring nut 62.

As will be understood from FIG. 6, the axial length of the spring 22 of the biasing means in its relaxed state combined with the axial length of the reduced diameter portion 60 of the drive screw 14 are together slightly greater than the axial length of the internal thread 18 of the drive nut 44 of the slide assembly 16. This configuration and dimensioning ensures that the spring 22 is effective in urging the slide assembly 16 in the extended position toward the drive screw 14. This biasing action of the spring 22 against the drive nut 44 toward the drive screw 14 promotes re-engagement of the internal and external threads 18 and 20 on rotation of the drive screw 14 in the reverse or clockwise direction.

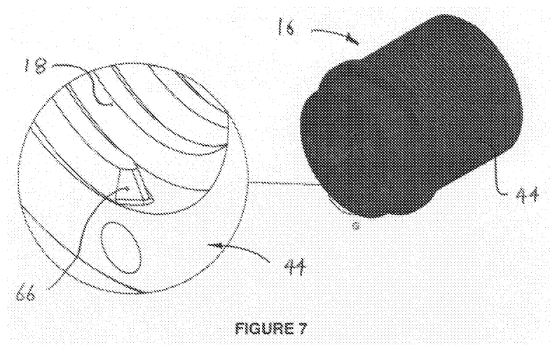

As best seen in FIG. 7, the internal thread 18 of the drive nut 44 of the slide assembly 16 is of a trapezoidal thread form. It is to be understood that the external thread 20 of the drive screw 14 is of a complementary trapezoidal thread form. Each of the internal and external threads 18 and 20 are tapered at their proximal and distal ends, respectively. This taper is seen at 66 in the detail view of the trapezoidal internal thread 18 of the drive nut 44. It will be understood that the tapered ends such as 66 of the threads 18/20 are configured to promote re-engagement with the slide assembly 16 in the extended position and upon rotation of the drive screw 14 in the reverse or clockwise direction. Conversely, with the slide assembly 16 in the extended position, forward or counter-clockwise rotation of the drive screw 14 causes final threads in the drive screw 14 and the drive nut 44 to “wipe” over one another. The biasing means or spring 22 causes the distal tapered end 66 of the internal thread 18 of the drive nut 44 to axially push into the corresponding tapered proximal end of the drive screw 14 where continued forward or counter-clockwise rotation causes a ratchet action with an associated “thunk” or similar sound.

Returning to FIGS. 1 and 4, the housing assembly 12 also includes a bearing arrangement 70 fixed to a proximal end 72 the outer casing 56. The bearing arrangement 70 includes a bearing housing 74 which in this example is screw fitted to the outer casing 56 and clamped to a driver housing 76 via a retaining nut 78. The driver housing 76 is configured for detachable coupling of the impact wrench 17 to enable rotation of the drive screw 14. It will be understood that the bearing arrangement 70 is configured to prevent axial movement of the drive screw 14 relative to the housing assembly 12 whilst permitting rotation of the drive screw 14 in both the forward and reverse directions.

Now that a preferred embodiment of the present invention has been described it will be apparent to those skilled in the art that the handheld railway spike puller has at least the following advantages:
1. the spike puller including its unique mechanism for release and re-engagement of the slide assembly from the drive screw reduces loads on components meaning the puller is of a lighter construction;
2. the lighter constructed handheld spike puller is relatively easy to operate and manoeuvre reducing OH&S risk;
3. the handheld spike puller utilising biasing means in promoting re-engagement of internal/external threads maintain its effectiveness in pulling rail spikes.

Those skilled in the art will appreciate that the invention as described herein is susceptible to variations and modifications other than those specifically described. For example, the shape and construction of the housing and slide assembly may vary where tubular or round sections are possible with a key and associated keyway permitting axial whilst restricting rotational movement. The biasing means may extend to other resiliently flexible elements and mount to the slide assembly rather than the drive screw whilst maintaining the biasing action between these components with the slide assembly in the extended position.

All such variations and modifications are to be considered within the scope of the present invention the nature of which is to be determined from the foregoing description.

1. A handheld railway spike puller comprising:
a housing assembly being generally elongate and at a proximal end adapted for coupling with a rotational driver;
a drive screw substantially housed within the housing assembly, said drive screw arranged for rotation via the rotational driver;
a slide assembly including an internal thread configured to engage an external thread of the drive screw which on rotation in a forward direction and a reverse direction effects sliding movement of the slide assembly within the housing assembly between an extended position and a retracted position, respectively, the internal and external threads designed on rotation of the drive screw in the forward direction to release from one another in the extended position of the slide assembly;
biasing means operatively to the drive screw, said biasing means being arranged on release of the internal and external threads to urge the slide assembly in the extended position axially toward the drive screw wherein rotation of the drive screw in the reverse direction effects re-engagement of the internal and external threads under the influence of the biasing means thereby providing sliding movement of the slide assembly toward the retracted position.

2. The handheld railway spike puller of claim 1 also comprising a pair of jaws associated with the slide assembly and arranged in the extended position of the slide assembly to be exposed from a distal end of the housing assembly for engagement of said jaws with a rail spike.

3. The handheld railway spike puller of claim 2 wherein the pair of jaws are pivotally coupled to one another and mounted to a distal end of the slide assembly via a clevis pin and mounting arrangement which on movement of the slide assembly toward the retracted position provides a scissoring action in the pair of jaws clamping about the rail spike and pulling it from a sleeper or associated sleeper plate.

4. The handheld railway spike puller of claim 1 wherein the housing assembly includes a foot arrangement at its distal end being adapted to contact the sleeper or the associated plate, said foot arrangement being designed during movement of the slide assembly between the extended and retracted positions to transmit axial forces from the drive screw and the slide assembly through the housing assembly to the sleeper or the associated plate for pulling of the rail spike from said sleeper or plate.

5. The handheld railway spike puller of claim 1 wherein the slide assembly includes a drive nut including the internal thread, said drive nut being mounted to a slide casing at its proximal end.

6. The handheld railway spike puller of claim 5 wherein the slide casing is hollow including a drive screw cavity arranged for receipt of a distal end of the drive screw during movement of the slide assembly between its extended and retracted positions.

7. The handheld railway spike puller of claim 1 wherein the slide assembly also includes one or more slide bushes mounted to the slide casing, said bushes being configured to cooperate with the housing assembly to permit axial movement of said slide assembly between the extended and retracted positions whilst preventing rotational movement relative to the housing assembly.

8. The handheld railway spike puller of claim 5 wherein the external thread of the drive screw terminates at a reduced diameter portion of said drive screw adjacent its distal end, the biasing means including a spring mounted about part of the reduced diameter portion and arranged on release of the internal and external threads in the extended position of the slide assembly to urge the slide assembly axially toward the drive screw.

9. The handheld railway spike puller of claim 8 wherein the biasing means also includes a spring nut mounted at the distal end of the drive screw and arranged for abutment with the spring.

10. The handheld railway spike puller of claim 8 wherein the axial length of the spring of the biasing means in its relaxed state combined with the axial length of the reduced diameter portion of the drive screw are together slightly greater than the axial length of the internal thread of the drive nut thereby ensuring the spring is effective in urging the slide assembly in the extended position toward the drive screw for re-engagement of the internal and external threads with rotation of the drive screw in the reverse direction.

11. The handheld railway spike puller of claim 5 wherein the internal thread of the drive nut and the external thread of the drive screw are of a trapezoidal thread form.

12. The handheld railway spike puller of claim 11 wherein each of the internal and external threads are tapered at their proximal and distal ends, respectively, said tapered ends being configured to promote re-engagement of said threads under the influence of the biasing means with the slide assembly in the extended position and upon rotation of the drive screw in the reverse direction.

13. The handheld railway spike puller of claim 1 wherein the housing assembly also includes a bearing arrangement fixed to an outer casing of the housing assembly at its proximal end, said bearing arrangement mounted about a proximal end of the drive screw and configured to prevent axial movement of said drive screw whilst permitting rotation of said screw in both the forward and reverse directions.

14. The handheld railway spike puller of claim 13 wherein the housing assembly further includes a driver housing mounted to a bearing housing of the bearing arrangement, said driver housing adapted for detachable coupling with the rotational driver.
